(19) United States
(12) Patent Application Publication
(10) Pub. No.: US 2025/0079026 A1
(43) Pub. Date: Mar. 6, 2025

(54) Whispering gallery mode fusion reactor with fast ignition

(71) Applicant: Janos Dobos, Pecs (HU)

(72) Inventor: Janos Dobos, Pecs (HU)

(21) Appl. No.: 18/240,362

(22) Filed: Aug. 31, 2023

(51) Int. Cl. G21B 1/05

(52) U.S. Cl. CPC G21B 1/05

(57) ABSTRACT

In order to achieve higher fusion efficiency, the invention separates the process of fusion plasma compression and fusion ignition into two. Plasma compression is performed with whispering gallery mode radiation, typically laser radiation. The ignition of hot spots created by compression is performed by the solution according to the invention by direct irradiation, typically by direct proton radiation. One of the advantages of separating compression and rapid ignition is that less energy consumption is sufficient to create fusion than with other solutions, moreover, smaller energy shocks do not break the hydrodynamic stability of the plasma, so the fusion is more efficient.

### BACKGROUND OF THE INVENTION

This description relates to the separation of the fusion plasma compression process and the fusion ignition process.

In the Lawrence Livermore National Laboratory of the United States, with an energy input of 2 MJ, a successful laser inertial confinement experiment was carried out based on the patent number WO2012064668A1 (“Indirect drive targets for fusion power”), with a fusion material compressed in a 2 mm diameter capsule in the year 2022 and in the year 2023.

In their 2020 publication “Generation of megatesla magnetic fields by intense-laser-driven microtube implosions”, M. Murakami and his colleagues used microtube implosion controlled by ultra-intense laser pulses to create ultra-high magnetic fields. The mega-electronvolt hot electrons produced by the laser and formed on the inner wall surface explode towards the cold central axis, where they create a strong peta-ampere spin current density and, as a result, a megatesla magnetic field.

According to the research “Strongly magnetized plasma produced by interaction of nanosecond kJ-class laser with snail targets” by T. Pisarczyk and colleagues, a polarized whispering gallery mode laser beam (500 J, 350 ps and 1.315 μm) produces hot particles that explode towards the cold central axis. The exploding ions and electrons create a magnetic field of 100 Tesla strength and a hot electron density of 10\hat{ }20 electrons/cm3 in the center of the target, which lasts for 10 ns.

M. Roth and his colleagues describe in their work “Focused Energy, A New Approach Towards Inertial Fusion Energy” that the separation of fusion material compression and fusion material ignition processes is associated with lower energy consumption and more efficient fusion combustion. After many years of research, it has been concluded that proton flash ignition is the most credible approach to commercialize fusion energy within the inertial confinement fusion approach. Once the hot spot region ignites and the bootstrapping alpha reactions begin to drive a supersonic combustion wave into the fuel, the pellet yield is determined only by the assembled fuel mass and areal density, which are limited only by the available drive laser energy. This approach could also pave the way for the exploration of advanced fuels by assembling targets where the combustion wave can begin to propagate into other adjacent fuel compositions. Whispering gallery mode plasma compression is not included in the description.

U.S. Ser. No. 18/299,151, the invention requested by the inventor, entitled “whispering gallery mode fusion reactor”, describes a whispering gallery mode fusion reactor, where the compression and ignition of the fusion material is provided by the compressive force of the whispering gallery mode radiation. The invention takes advantage of the advantage that any radiation, including neutron, ion, alpha, beta, gamma, X-ray, and laser radiation, can be forced into a whispering gallery mode in the case of a small angle of incidence.

The advantageous properties of the above solutions inspired the inventor to further develop the invention of U.S. Ser. No. 18/299,151

### SUMMARY OF THE INVENTION

In order to achieve higher fusion efficiency, the invention separates the process of fusion plasma compression and fusion ignition into two. Plasma compression is performed with whispering gallery mode radiation, typically laser radiation. However, the compression can be performed even with subatomic particle radiation or electromagnetic radiation (for example: neutron, ion, alpha, beta, gamma, X-ray, ultraviolet radiation) since these radiations can be forced into a whispering gallery mode at a small angle of incidence. The compression works on the principle physics similar to the researches of T. Pisarczyk already mentioned. A polarized whispering gallery mode laser beam of ˜500 J energy, 350 ps and 1.315μ power introduced into a 2 mm diameter target in the whispering gallery mode creates hot particles on the inner surface of the wall that explode towards the cold central axis, compressing the fusion material. The compression is aided by the magnetic fields of the exploding ions and electrons with a strength greater than 100 Tesla remaining for a period of 10 ns. The ignition of hot spots created by double compression is performed by the solution according to the invention by direct irradiation, typically by direct proton radiation. One of the advantages of separating compression and rapid ignition is that less energy consumption is sufficient to create fusion than with other solutions, moreover, smaller energy shocks do not break the hydrodynamic stability of the plasma, so the fusion is more efficient. The invention is best understood with reference to the drawings.

### BRIEF DESCRIPTION OF FIGURES

FIG. 1A, FIG. 1B, FIG. 2C, FIG. 3D schematic drawings depict the concept and process of the whispering gallery mode fusion reactor with fast ignition solution.

FIG. 2 schematic drawings shows a schematic diagram of an embodiment of the whispering gallery mode fusion reactor with fast ignition solution, where the fusion process takes place in a 2 mm diameter rugby ball-shaped capsule.

FIG. 3 schematic drawings the fusion process is assisted by the energy from the fusion plasma collision of two projectiles and the energy of magnetic generators.

FIG. 4A, FIG. 4B, FIG. 4C schematic drawings of FIG. 3 shows the first three phases of operation of the embodiment.

FIG. 5A, FIG. 5B are schematic drawings of FIG. 3 depicts the fourth and fifth phases of operation of the embodiment.

FIG. 6A, FIG. 6B schematic drawings show an embodiment of the whispering gallery mode fusion reactor with fast ignition solution, where we keep the separation of whispering gallery mode compression and fast ignition, however we introduce additional energies into the plasma by means of electrostatic fields, and then the compression with a Z-pinch solution we strengthen it.

FIG. 7. A conceptual drawing of an easy-to-fabrication embodiment.

### DETAILED DESCRIPTION OF INVENTION

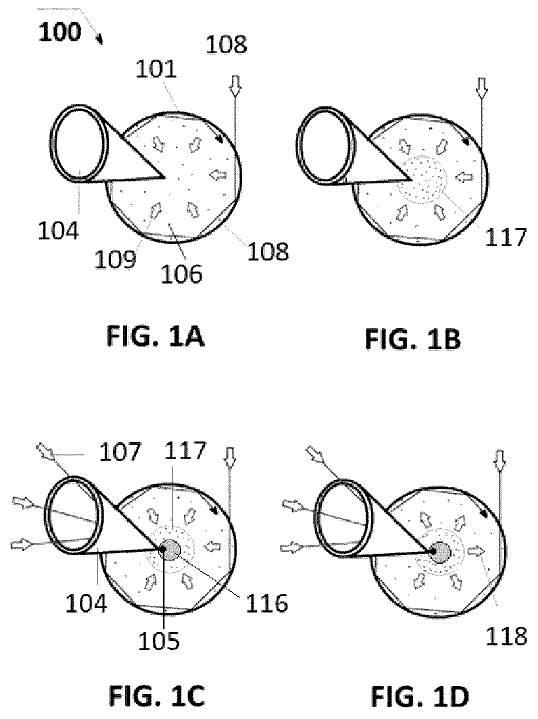

FIG. 1A, FIG. 1B, FIG. 1C, FIG. 1D schematic drawing depicts the concept and process of the 100 whispering gallery mode fusion reactor with fast ignition solution. From the schematic drawings, it can be seen that flash ignition separates the compression from the ignition phase by adding a high-intensity charged particle beam that ignites part of the fuel hot spot.

According to the schematic drawings, the 100 whispering gallery mode fusion reactor with fast ignition comprises a 101 reactor space suitable for circulating radiation in a whispering gallery mode, which comprises at least one 108 neural network controlled axially circulating whispering gallery mode plasma compression radiation and at least one 117 isolated plasma compressed to fusion conditions by whispering gallery mode radiation, which comprises at least one 116 hot spot which comprises at least one 105 high-intensity, incendiary radiation, typically proton radiation.

FIG. 1A. according to the schematic drawing, in the first phase we direct the 108 neural network controlled axially circulating whispering gallery mode plasma compression radiation into a 101 reactor space suitable for circulating radiation in a whispering gallery mode. This solution creates on the inner wall surface a 109 generated compressive radiation generated that compresses the fusion fuel towards the cold center point.

FIG. 1B. In the second phase according to the previously mentioned experiment by T. Pisarczyk, the 100 Tesla magnetic field remaining for 10 ns and the 10\hat{ }20 electron/cm3 hot electron density create the 117 isolated plasma compressed to fusion conditions.

FIG. 1C. In the third phase, 107 high intensity, incendiary radiation generating radiation, typically neural network controlled laser radiation, is introduced into a 104 high-intensity radiation, typically proton radiation generating injector. The 105 high-intensity, incendiary radiation, typically proton radiation, enters a part of the 116 hot spot of the 117 isolated plasma compressed to fusion conditions. The first three phases take about 500-1500 ps in total.

FIG. 1D. In the fourth phase, the process of 118 fusion burn is created.

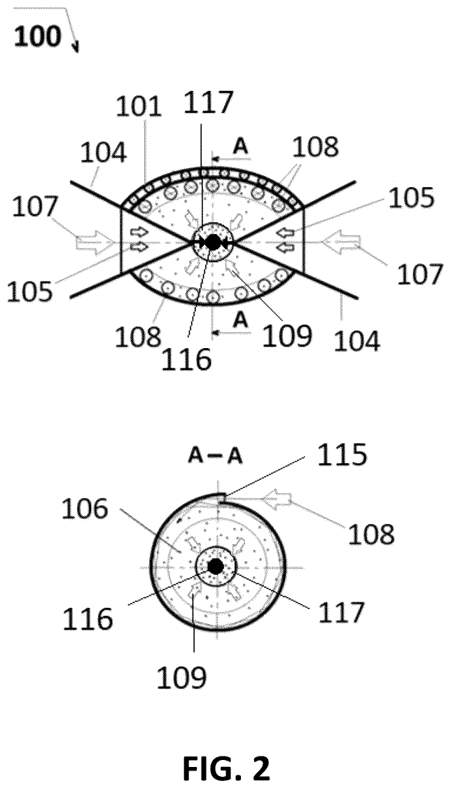

FIG. 2. shows a schematic drawing of an embodiment of the solution named 100 whispering gallery mode fusion reactor with fast ignition, where the fusion process is typically realized in a 2 mm diameter rugby ball shaped capsule. In the first phase through 115 LEHL foil we direct the 108 neural network controlled axially circulating whispering gallery mode plasma compression radiation into a 101 reactor space suitable for circulating radiation in a whispering gallery mode. This solution creates on the inner wall surface a 109 generated compressive radiation generated that compresses the fusion fuel towards the cold center point. In the second phase according to the previously mentioned experiment by T. Pisarczyk, the 100 Tesla magnetic field remaining for 10 ns and the 10\hat{ }20 electron/cm3 hot electron density create the 117 isolated plasma compressed to fusion conditions. In the third phase, 107 high intensity, incendiary radiation generating radiation, typically neural network controlled laser radiation, is introduced into the two 104 high-intensity radiation, typically proton radiation generating injector. The two 105 high-intensity, incendiary radiation, typically proton radiation, enters a part of the 116 hot spot of the 117 isolated plasma compressed to fusion conditions. The first three phases take about 500-1500 ps in total. This embodiment can be used in power plants, where the fusion target is a capsule, described in M. Roth et al.'s work entitled “Focused Energy, A New Approach Towards Inertial Fusion Energy”.

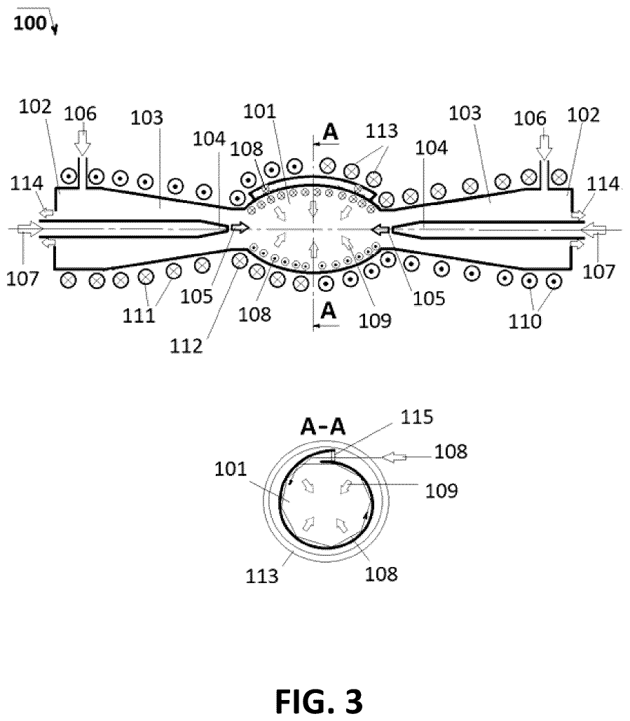

FIG. 3. schematic drawing shows the conceptual drawing of an embodiment of 100 whispering gallery mode fusion reactor with fast ignition solution, where the fusion process is assisted by the energy from the fusion plasma collision of two projectiles and the energy of magnetic generators. The devices comprises typically 2 mm diameter the 101 reactor space suitable for circulating radiation in a whispering gallery mode and two the 102 fusion fuel-receiving, plasma-forming precompression accelerator chamber, and two the 103 plasma compression accelerator chamber.

The devices comprises 104 high-intensity radiation, typically proton radiation generating injector, 105 high-intensity, incendiary radiation, typically proton radiation, 106 fusion fuel, 107 high intensity, incendiary radiation generating radiation, typically neural network controlled laser radiation, 108 neural network controlled axially circulating whispering gallery mode plasma compression radiation, 109 generated compressive radiation, 110 neural network controlled-magnetic field generating plasma ring compressing coils, 111 neural network controlled-magnetic field generating plasma ring compressing-transmitting-accelerating coils, 112 neural network controlled magnetic field generating plasma enclosing magnetic mirror coils, 113 neural network controlled magnetic field generating, plasma encapsulating coils, 114 neural network controlled vacuum pumps, 115 LEHL foil. This embodiment can be advantageously used in aneutron fusion power plants that are being developed by Helion Energy Inc, where the flux changes of the magnetic field created by the fusion energy are converted directly into electric current.

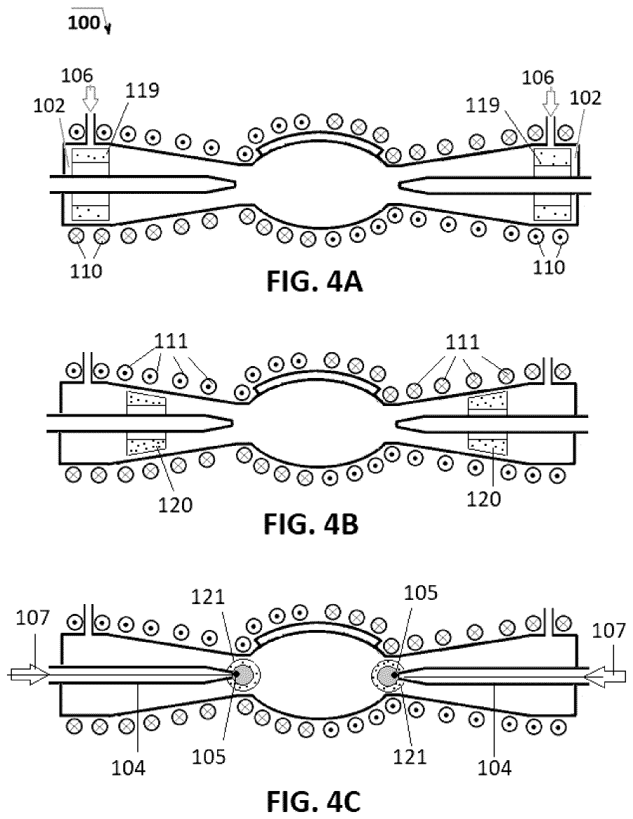

FIG. 4A. The first working phase of this embodiment of the 100 whispering gallery mode fusion reactor with fast ignition. The 106 fusion fuel is injected into the 102 fusion fuel-receiving, plasma-forming precompression accelerator chamber located at the two ends of the device, where the 110 neural network controlled-magnetic field generating plasma ring compressing coils form the 119 compressed plasma first state.

FIG. 4B shows the second work phase, where the 111 neural network controlled-magnetic field generating plasma ring compressing-transmitting-accelerating coils compressed into an ever smaller ring accelerate a speed greater than 250 km/s the 120 compressed plasma second state.

FIG. 4 C. Conceptual drawing shows the third work phase, where 105 high-intensity, incendiary radiation, typically proton radiation, is introduced into the 116 hot spots of 121 projectiles fired against each other are plasma, which is created with a 104 high-intensity radiation, typically proton radiation generating injector, in which introduce the 107 high intensity, incendiary radiation generating radiation, typically neural network controlled laser radiation.

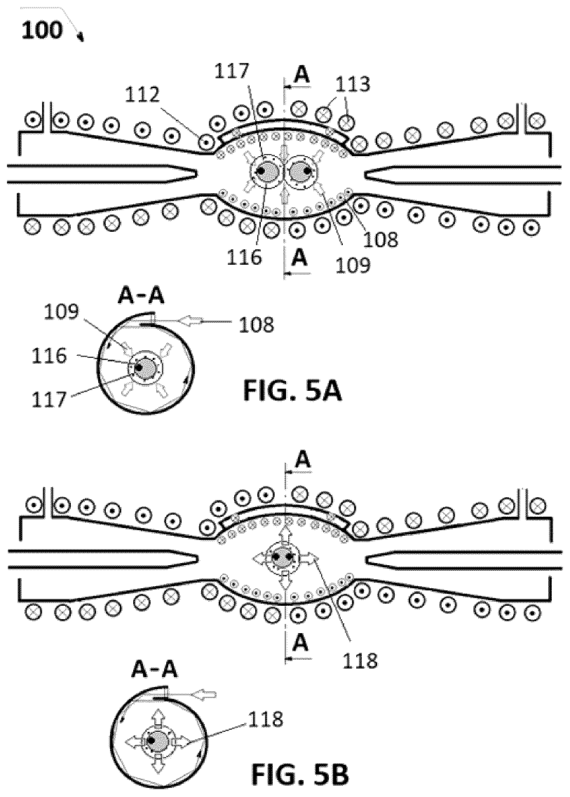

FIG. 5A. The conceptual drawing depicts the fourth phase of the operation, where we introduce the 108 neural network controlled axially circulating whispering gallery mode plasma compression radiation, which, according to the previously mentioned experiment by T. Pisarczyk, creates 109 generalt compressive radiation on the inner wall surface, which, together with the 113 neural network controlled magnetic field generating, plasma encapsulating coils, further compresses the 116 hot spot of 117 isolated plasma compressed to fusion conditions, between the 112 neural network controlled magnetic field generating plasma enclosing magnetic mirror coils.

FIG. 5B. The conceptual drawing depicts the fifth phase of operation, where the 118 fusion burn process takes place.

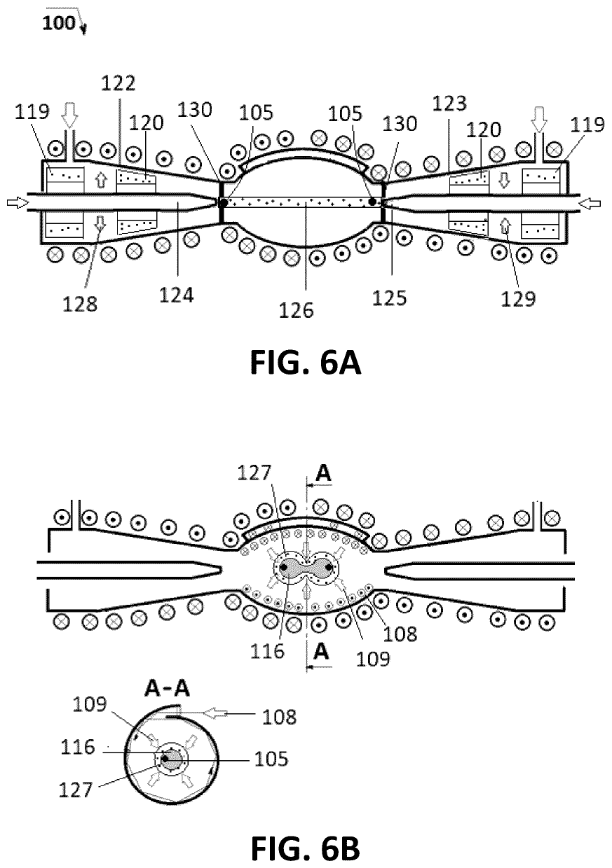

FIG. 6. The conceptual drawing shows an embodiment of the 100 whispering gallery mode fusion reactor with fast ignition invention, where we maintain the separation of whispering gallery mode compression and fast ignition, but introduce additional energies into the plasma by means of electrostatic fields, and then the compression we strengthen it with a Z pinch. Between the 122 anode external electrode and the 124 fast ignition injector generating radiation, typically proton radiation, as cathode internal electrode, a 128 first electron flow increasing plasma energy takes place.

Between the 123 cathode external electrode and the 125 fast ignition injector generating radiation, typically proton radiation, as anode internal electrode, an 129 second electron flow increasing plasma energy takes place. The 130 dielectric insulators separates the 123 cathode external electrode from the 122 anode external electrode. Since works the 124 fast ignition injector generating radiation, typically proton radiation, as cathode internal electrode and the 125 fast ignition injector generating radiation, typically proton radiation, as anode internal electrode, therefore current flows in the plasma between them, thus creating a process known to a specialist the 126 compressed Z-pinch plasma columns. As previously described, the 119 compressed plasma first state transforms into the 120 compressed plasma second state, accelerates to a speed greater than 250 km/s, while absorbing electrostatic energy, and then compacts with Z-pinch into the 126 compressed Z-pinch plasma columns. After that, he receives 105 high-intensity, incendiary radiation, typically proton radiation.

A FIG. 6B. The schematic diagram shows that the 108 neural network controlled axially circulating whispering gallery mode plasma compression radiation creates the 109 generated compressive radiation that further compresses the 127 whispering gallery mode radiation isolated Z-pinch plasma, which contains a 116 hot spots, which contains two 105 high-intensity, incendiary radiation, typically proton radiation. The solution can be used in fusion power plants built by Zap Energy Inc, where the machine is a ˜2 meter long metal pipe with a cathode running down the middle. There is a voltage between the central cathode and the anode. There, fusion fuel is injected into the back of the machine, which is ionized by Paschen decay, creating plasma. This plasma, while absorbing energy, sweeps forward in the gap between the cathode and the anode, and then compresses with a Z pinch.

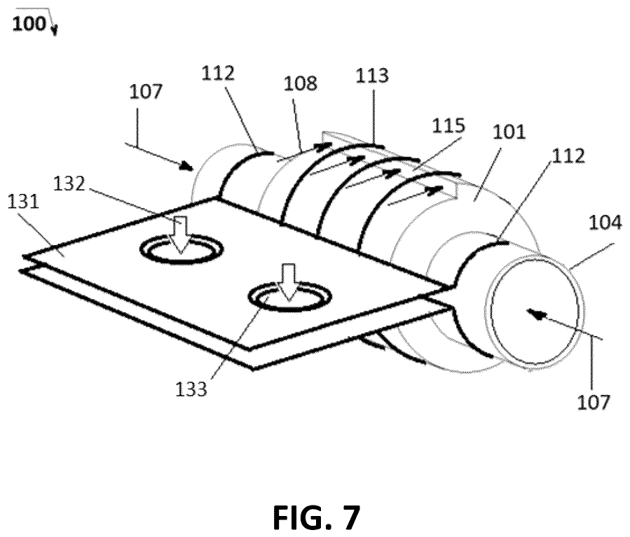

FIG. 7. The 100 whispering gallery mode fusion reactor with fast ignition shows an embodiment of the invention that can be easily manufactured by simple rolling, for example, from a 20 micrometer thick copper sheet. The solution characterized in that it comprises: 101 reactor space suitable for circulating radiation in a whispering gallery mode, 104 high-intensity radiation, typically proton radiation generating injector, 107 high intensity, incendiary radiation generating radiation, typically neural network controlled laser radiation, 108 neural network controlled axially circulating whispering gallery mode plasma compression radiation, 115 LEHL foil. Since neural network controlled axially circulating whispering gallery mode plasma compression radiation photon energy is only efficiently transferred to the plasma if the largest diameter of the reactor space is below 2 mm, it is therefore advisable to used well-known by experts a small-sized, easy to manufacture 131 laser-driven magnetic field generators, where the drive takes place with the 132 laser through the 133 hole. The 131 laser-driven magnetic field generators contains two 112 neural network controlled magnetic field generating plasma enclosing magnetic mirror coils and three 113 neural network controlled magnetic field generating, plasma encapsulating coils.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

1. Whispering gallery mode fusion reactor with fast ignition (100) characterized in that it comprises:
a reactor space suitable for circulating radiation in a whispering gallery mode (101), which comprises:
at least one neural network controlled axially circulating whispering gallery mode plasma compression radiation (108),
at least one isolated plasma compressed to fusion conditions (117), which comprises:
at least one hot spot (116) which comprises:
at least one high-intensity, incendiary radiation, typically proton radiation (105).

2. Neural network controlled axially circulating whispering gallery mode plasma compression radiation (108) according to claim 1, characterized by the or subatomic particle radiation or electromagnetic radiation.
